(19) United States
(12) Patent Application Publication
(10) Pub. No.: US 2026/0243303 A1
(43) Pub. Date: Aug. 20, 2026

(54) WIRE RACEWAY BALL BEARING, CAGE STRIP, METHOD OF FORMING THE SAME, AND CAGE

(71) Applicant: AKTIEBOLAGET SKF, GOTEBORG (SE)

(72) Inventors: Yanqin GAO, Shanghai (CN); Han WU, Shanghai (CN); Meng ZHANG, Shanghai (CN)

(21) Appl. No.: 19/536,556

(22) Filed: Feb. 11, 2026

(30) Foreign Application Priority Data
Feb. 19, 2025 (CN) 202510187809.8

(51) Int. Cl. F16C 33/42; F16C 19/06; F16C 33/38; F16C 33/41

(52) U.S. Cl. CPC F16C 33/42; F16C 19/06; F16C 33/3887; F16C 33/41

(57) ABSTRACT

A wire raceway ball bearing includes a cage having a plurality of pockets, each pocket being configured to accommodate one ball. Each pocket has a pair of claws opposing each other in a circumferential direction, and each claw extends from an inner wall of the pocket in a first radial direction towards a radially inner side and in a second radially direction toward a radially outer side of the pocket. Also, a radial thickness of each claw is 44% to 47% of the ball diameter and an axial width of each claw is 58% to 60% of the ball diameter.

### CROSS-REFERENCE

This application claims priority to Chinese patent application no. 202510187809.8 filed on Feb. 19, 2025, the contents of which are fully incorporated herein by reference.

### TECHNICAL FIELD

The present disclosure is directed to a wire raceway ball bearing, a cage strip and method of forming the same, and a cage for a wire raceway ball bearing.

### BACKGROUND

In the field of large equipment, such as CT machines, shafts with particularly large diameters are usually used, and the bearings that are used in the shafts are also very large. Wire raceway ball bearings are well-suited for such applications.

Accordingly, the cage of a wire raceway ball bearing also has a very large diameter. For example, a wire raceway ball bearing for a CT machine may have a cage pitch circle with a diameter of 1-1.5 m, which cage pitch circle is a circle substantially passing through the centers of all pockets of the cage, such as the geometric centers or centroids of the pockets. The circumference of the cage may reach more than 3 m.

A cage for a wire raceway ball bearing is cut from a roll of cage strip, which may have a length of more than 10 m, and such cage strip may be manufactured by injection molding. After cutting off a cage according to the diameter of the wire raceway ball bearing, it is also necessary to fit the balls used as bearing rolling elements into the cage pockets one by one. During assembly, problems such as the balls falling out of the pockets often occur.

An example of a conventional wire raceway ball bearing is illustrated in FIG. 4. The wire raceway ball bearing includes two raceway supports 100, four wires 102 that form raceways, and a cage 104 for holding and spacing a plurality of balls 106 (only one of which is illustrated).

### SUMMARY

In response to the above-mentioned problems and needs, the present disclosure proposes a new technical solution, which solves the above problems and brings other technical effects by adopting the following technical features.

The present disclosure provides a wire raceway ball bearing comprising: a cage having a plurality of pockets, each pocket configured to accommodate one ball; wherein each pocket has a pair of claws opposing each other in a circumferential direction and each claw extends from an inner wall of the pocket in a radial direction towards a radially inner side and a radially outer side; and wherein the thickness of each claw in the radial direction is 44% to 47% of the ball diameter and the width of each claw in the axial direction is 58% to 60% of the ball diameter.

Preferably, the cage is formed solely from long chain nylon. Preferably, the long-chain nylon is PA11 or PA12 or PA1010 or PA1012 or PA1212.

Preferably, the cage is formed by a continuous injection molding process and comprises a plurality of cage units, and the ends of adjacent cage units are connected by secondary melt-solidification in the continuous injection molding process.

Preferably, there is a gap between the opposing ends of the cage, preferably the gap is 0.19% to 0.65% of the circumference of the cage.

The present disclosure provides a cage strip for forming a cage for a wire raceway ball bearing comprising balls, the cage strip comprising: a plurality of pockets, each pocket being configured to accommodate one ball, and each pocket having a pair of claws opposing each other in the length direction of the cage strip, and each claw extending from an inner wall of the pocket towards both sides in the thickness direction of the cage strip; and wherein the thickness of each claw in the thickness direction of the strip of cages is 44% to 47% of the ball diameter, and the width of each claw in the width direction of the strip of cages is 58% to 60% of the ball diameter.

Preferably, the cage strip is formed solely from long chain nylon. Preferably, the long-chain nylon is PA11 or PA12 or PA1010 or PA1012 or PA1212.

Preferably, the cage strip is formed by a continuous injection molding process and comprises a plurality of cage units, and the ends of adjacent cage units are connected by secondary melt-solidification in the continuous injection molding process.

The present disclosure provides a cage for a wire raceway ball bearing, wherein the cage is formed by cutting a certain length of cage strip according to the size of the wire raceway ball bearing, wherein the cage strip is a cage strip as described above.

The present disclosure provides a method of forming a cage strip as described above, comprising: setting the temperature of the mold for the cage strip to 60 to 100° C. during a continuous injection molding process for forming the cage strip.

By means of the design of the cage according to the disclosure, it is ensured that the balls will not fall out of the pockets due to bending or twisting of the cage during fitting of the balls into the pockets, and it is also possible to prevent the balls from getting stuck in the pockets during operation of the wire raceway ball bearing. Therefore, the present disclosure not only solves the problems that arise during the assembly of long-length cages, but also produces an effect of facilitating the operation of wire raceway ball bearings.

### BRIEF DESCRIPTION OF DRAWINGS

FIG. 1 is a schematic perspective view of a cage according to an embodiment of the disclosure.

FIG. 2 is a schematic view of a cage unit of a cage according to an embodiment the disclosure.

FIG. 3A is a view showing a claw at the inner surface of the pocket looking from the center of the pocket toward the claw.

FIG. 3B is a plan view of two of the pockets of the cage of FIG. 1.

FIG. 4 is a sectional view through a conventional wire race bearing.

FIG. 5 is a plan view of a portion of a cage strip according to the present disclosure.

### DETAILED DESCRIPTION

In order to make the purpose, technical solutions and advantages of the technical solutions of the present disclosure clearer, the technical solutions of the embodiments of the present disclosure will be clearly and completely described below with reference to the accompanying drawings of specific embodiments of the present disclosure. The same reference numbers in the drawings represent the same parts. It should be noted that the described embodiments are some, not all, of the embodiments of the present disclosure. Based on the described embodiments of the present disclosure, all other embodiments obtained by those of ordinary skill in the art without creative efforts fall within the scope of protection of the present disclosure.

Possible implementations within the scope of protection of the present disclosure may have fewer components than the embodiments illustrated in the figures, have other components not illustrated in the figures, different components, differently arranged components or differently connected components, etc. Furthermore, two or more components in the figures may be implemented within a single component, or a single component shown in the figures may be implemented as multiple separate components.

Unless otherwise defined, technical or scientific terms used herein shall have their ordinary meaning as understood by a person of ordinary skill in the art to which this disclosure belongs. The terms “first”, “second” and similar words used in the specification and claims of this disclosure do not indicate any order, quantity or importance, but are only used to distinguish different components. When the number of components is not stated, the number of components can be one or more; likewise, words such as “a,” “the,” “the,” and similar words do not necessarily indicate a quantitative limitation. Words such as “include” or “include” mean that the elements or items appearing before the word include the elements or items listed after the word and their equivalents, without excluding other elements or items. Words such as “installation”, “setting”, “connection” or “connection” are not limited to physical or mechanical installation, setting, and connection, but may include electrical installation, setting, and connection, whether direct or indirect. “Up”, “down”, “left”, “right”, etc. are only used to represent the relative orientation relationship when the device is used or the orientation relationship shown in the drawings. When the absolute position of the described object changes, the relative position relationships may also change accordingly.

For ease of explanation, the direction of the rotational axis of the bearing is referred to herein as the axial direction, and the direction perpendicular to the axial direction is referred to as the radial direction.

Preferable embodiments according to the present disclosure are described below with reference to the accompanying drawings.

A wire raceway ball bearing may include an outer ring housing, steel wires with raceways, balls used as rolling elements, a cage, an inner ring housing, etc. It should be understood that wire raceway ball bearings according to the present disclosure may have the same or similar components. A wire raceway according to the present disclosure may comprise the conventional wire raceway ball bearing is illustrated in FIG. 4 with the conventional cage replaced with a cage according to the present disclosure.

As mentioned previously, a wire raceway ball bearing has a large diameter and cages of a wire raceway ball bearing also have a large diameter and a long length. Such a cage is usually integrally formed by injection molding process. Specifically, manufacturers will produce a cage strip of a very long length (for example 10 m or more) by injection molding. The user may then cut the cage with a certain length (for example about 3 m) according to the diameter of the wire raceway ball bearing to be applied.

Subsequently, hundreds of balls are fitted into the corresponding pockets of the cage. In this process, the cage is usually placed in an operating station and the balls are assembled into the pockets one by one by a worker manually or by operating an assembly tool. However, in the process of fitting more balls after fitting a portion of the balls, for example after fitting tens of balls, the part of cage fitted with the balls may leave the operating station and may be bent or twisted due to the length of cage, and this bending or twisting is often difficult to avoid, which may further cause a problem of the already fitted balls falling out of the pockets.

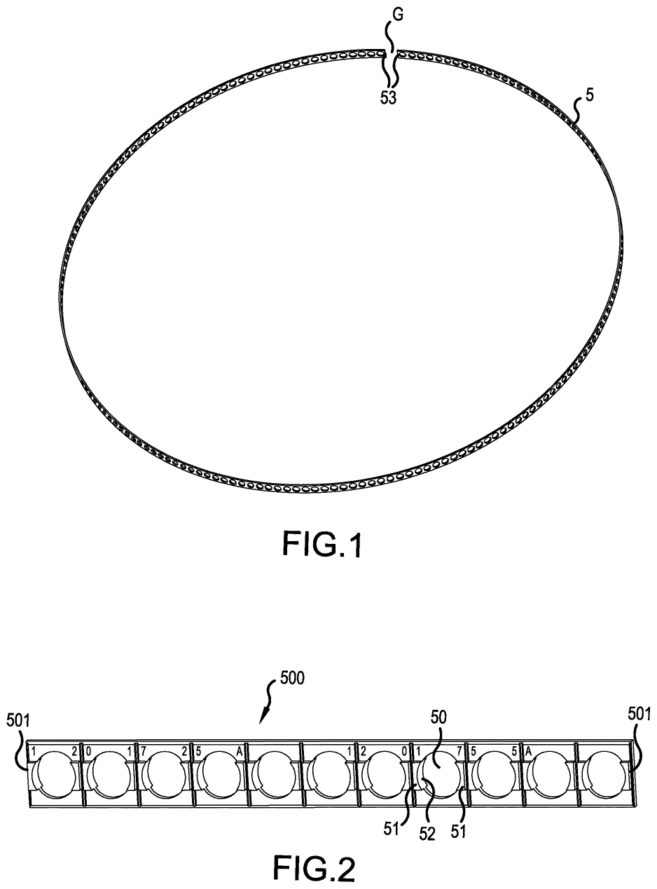

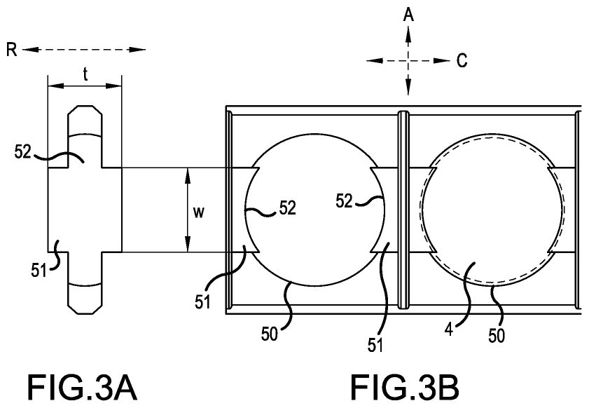

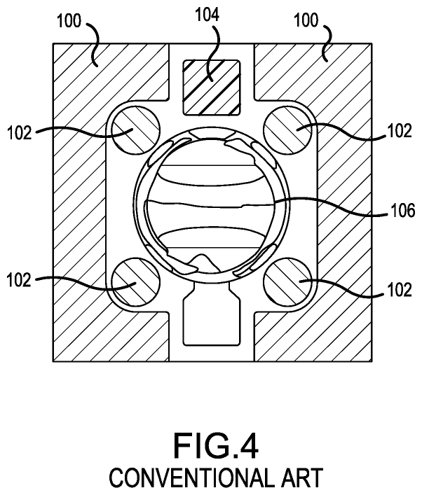

FIG. 1 shows a cage 5 according to the disclosure and FIG. 2 shows a cage unit 500, a plurality of which may be connected together to form the cage 5 as described in more detail below. FIG. 3A is view of the inner wall of a pocket looking from the center of the pocket and FIG. 3B is a plan view of two of the pockets 50 in the cage 5. In the side view of FIG. 3A, the radial direction is labelled with R, in the plan view of FIG. 3B the axial direction is labelled A and the circumferential direction is labelled with C; a ball 4 is shown by a dashed circle in the plan view.

According to one aspect of the disclosure, the cage 5 of a wire raceway ball bearing includes a plurality of pockets 50, each pocket 50 being configured to accommodate one ball 4 (shown by the dashed circle in FIG. 3B). Furthermore, each pocket 50 includes a pair of claws 51 opposing each other in the circumferential direction C, and each claw 51 extends from the inner wall 52 of the pocket 50 in the radial direction R, a first portion of each claw 51 extending radially inwardly and a second portion of each claw extending radially outwardly. The thickness t of each claw 51 in the radial direction R is 44% to 47% of the ball diameter, and the width w of each claw 51 in the axial direction A is 58% to 60% of the ball diameter.

By such a design of the claws 51 of the cage 5, it is possible to ensure that the balls 4 will not fall out of the pocket 50 due to bending or twisting of the cage during the fitting of the balls 4 into the pockets 50. Furthermore, further tests have found that this cage design also prevents the balls from getting stuck in the pockets during operation of the wire raceway ball bearing. Therefore, the present disclosure not only solves the problems during the assembly process of the long-length cage, but also produces an effect of facilitating the operation of the wire raceway ball bearing.

Therefore, the present disclosure further proposes based on the above-mentioned optimal design of the claw size that the cage is formed only of long-chain nylon. More preferably, the long-chain nylon is PA11 (polyundecanolactam) or PA12 (polylaurolactam) or PA1010 or PA1012 or PA1212.

Long-chain nylons (especially PA11 or PA12 or PA1010 or PA1012 or PA1212) have superior toughness, impact resistance and dimensional stability. Through the inventors' research, it is found that using long-chain nylon to manufacture the cage with the above-mentioned optimal claw size design can not only better solve the problem of the ball falling from the pocket when the cage is bent or twisted, but also there is no need to operate complicated assembly tools, and workers can easily manually assemble the balls into the pockets, which not only improves the efficiency and success of assembly of the balls into the cage, but also reduces labor intensity and cost. In the case where PA11 or PA12 or PA1010 or PA1012 or PA1212 is selected to make the cage, lubricant compatibility and dimensional stability can be better provided.

Preferably, as shown in FIG. 2, the cage may be formed through a continuous injection molding process and includes a plurality of cage units 500, and the ends 501 of adjacent cage units 500 are secondarily melt-solidified in the continuous injection molding process (in short, a separate mold can be added to the continuous injection molding process to heat and melt the material of the ends and complete the melt-solidification molding process in a mold, to connect the ends 501 of adjacent cage units 500), thereby forming an overall continuous cage rather than a cage spliced as individual segments. This further improves the overall stability of the cage and optimizes the loading status.

Preferably, see FIG. 1, there is a gap G between the opposing ends 53 of the cage 5. Preferably, the gap G is 0.19% to 0.65% of the circumference of the cage 5. Since the wire raceway ball bearing experiences temperature and humidity changes during operation, when the temperature rises, the cage material will expand. Therefore, by setting the gap G as mentioned above, the cage is provided with space for material expansion, to avoid the balls getting stuck in the pockets. At the same time, provision of this gap G will not occupy further pocket positions, increasing the number of balls that can be held by the cage, increasing load capacity of the wire raceway ball bearing, and reducing noise generated during operation of the wire raceway ball bearing.

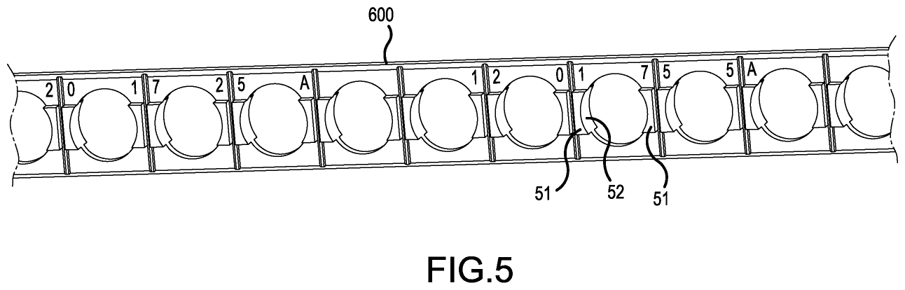

According to another aspect of the present disclosure, the present disclosure provides a cage strip 600, shown in FIG. 5, for forming the cage 5 for the wire raceway ball bearing. It should be understood that the cage strip is typically an elongated strip (e.g. above 10 m in length) and therefore has a length direction, a width direction and a thickness direction, corresponding respectively to the circumferential direction C, the axial direction A and the radial direction R of the cage 5 as previously described. Only a portion of the cage strip 600 is illustrated in FIG. 5.

Furthermore, the cage strip includes a plurality of pockets 50, each pocket 50 is intended to accommodate one ball 4, and each pocket 50 has a pair of claws 51 opposing each other in the length direction of the cage strip, and each claw 51 extends from the inner wall 52 of the pocket 50 towards both sides in the thickness direction of the cage strip. The thickness t of each claw 51 in the thickness direction of the cage strip is 44% to 47% of the ball diameter. The width w of each claw 51 in the width direction of the cage strip is 58% to 60% of the ball diameter.

Preferably, the thickness t of each claw 51 in the thickness direction of the cage strip is 46% of the ball diameter, and the width w of each claw 51 in the width direction of the cage strip is 58% of the ball diameter.

Preferably, the cage strip is formed solely from long chain nylon. Preferably, the long-chain nylon is PA11 or PA12 or PA1010 or PA1012 or PA1212.

Preferably, the cage strip is formed through a continuous injection molding process and includes a plurality of cage units 500, and the ends 501 of adjacent cage units 500 are connected by secondary melt-solidification in the continuous injection molding process.

This cage strip can be provided to the user in a form of roll, and the user can cut a certain length of the cage strip to form the desired cage according to the size of a wire raceway ball bearing. There is no need to perform a new design for a bearing of a certain size. Therefore, the present disclosure is suitable for bearings with different sizes and can reduce costs. Moreover, the cage thus formed has the advantages and technical effects as previously described.

According to a further aspect of the disclosure, the disclosure provides a method of forming the cage strip as described above, comprising: setting a temperature of a mold for the cage strip to 60-100° C. during a continuous injection molding process for forming the cage strip.

The exemplary embodiments of the present disclosure have been described in detail above with reference to preferable embodiments. However, those skilled in the art will understand that various modifications can be made to the above specific embodiments without departing from the concept of the present disclosure. Modifications, and various technical features and structures proposed in the present disclosure can be made in various combinations without exceeding the scope of protection of the present disclosure, which is determined by the appended claims.

What is claimed is:

1. A wire raceway ball bearing comprising:
a cage having a plurality of pockets, each pocket being configured to accommodate one ball having a diameter;
wherein each pocket includes a pair of claws opposing each other in a circumferential direction and each claw extends from an inner wall of the pocket in a first radial direction towards a radially inner side and a second radial direction towards a outer side; and
wherein a radial thickness of each claw is 44% to 47% of the ball diameter and an axial width of each claw is 58% to 60% of the ball diameter.

2. The wire raceway ball bearing according to claim 1,
wherein the cage comprises long chain nylon.

3. The wire raceway ball bearing according to claim 1,
wherein the cage comprises PA11 or PA12 or PA1010 or PA1012 or PA1212.

4. The wire raceway ball bearing according to claim 3,
wherein the cage comprises a plurality of cage units connected end to end.

5. The wire raceway ball bearing according to claim 1,
wherein the cage includes a circumferential gap between a first end of the cage and a second end of the cage.

6. The wire raceway ball bearing according to claim 5, wherein the gap is 0.19% to 0.65% of a circumference of the cage.

7. The wire raceway ball bearing according to claim 1,
wherein the cage consists of PA11 or PA12 or PA1010 or PA1012 or PA1212.

8. The wire raceway ball bearing according to claim 1,
including a first wire race and a second wire race,
wherein each of the plurality of pockets holds a respective one of the plurality of balls.

9. A cage strip for forming a cage for a wire raceway ball bearing, the cage strip comprising:
an elongated strip of material having a length and a width and a thickness and including a plurality of pockets, each pocket being configured to accommodate one ball having a ball diameter,
wherein each pocket includes a pair of claws opposing each other in a length direction of the elongated strip of material,
wherein each claw of the pair of claws includes a first portion projecting from an inner wall of the pocket in a first thickness direction of the elongated strip of material and a second portion projecting from the inner wall of the pocket in a second thickness direction of the elongated strip of material opposite the first thickness direction of the elongated strip of material; and
wherein a thickness of each claw in the thickness direction of the elongated strip of material is 44% to 47% of the ball diameter, and a width of each claw in a width direction of the elongated strip of material is 58% to 60% of the ball diameter.

10. The cage strip according to claim 7,
wherein the elongated strip of material comprises PA11 or PA12 or PA1010 or PA1012 or PA1212.

11. A method of forming a cage for a wire raceway ball bearing, the method comprising:
providing a cage strip according to claim 8, and
bending the elongated strip of material into a ring while leaving a gap between a first end of the elongated strip of material and a second end of the elongated strip of material.
